(19) United States
(12) Patent Application Publication
(10) Pub. No.: US 2015/0108773 A1
(43) Pub. Date: Apr. 23, 2015

(54) MOVABLE SECURITY MECHANISM FOR THE HANDLES OF MOTOR VEHICLE DOORS

(71) Applicant: Guillermo Elias De Leon Espinal, Santo Domingo (DO)

(72) Inventor: Guillermo Elias De Leon Espinal, Santo Domingo (DO)

(21) Appl. No.: 14/390,174

(22) PCT Filed: Apr. 25, 2013
(86) PCT No.: PCT/DO2013/000002

§ 371 Date: Oct. 3, 2014

(30) Foreign Application Priority Data
Apr. 27, 2012 (DO) P20120123
Apr. 25, 2013 (CH) WO2013159783

(51) Int. Cl. E05B 85/10

(52) U.S. Cl. CPC E05B 85/10
USPC 292/336.3

(57) ABSTRACT

The present invention relates to an automatic method to strengthen security at external door handles of cars. This would ensure that handles a few inches to slide back (or into the inside of the door) to cover cap then a close and completely seal the hole in the outside handle. This would happen, the driver found inside the vehicle when driving or exit the vehicle and active the alarm. One of the most important parts of this method is that hiding outer handles on the inside of the doors, because the integrity of the conductor is protected when it is inside, because though forget to place locks, doors become disabled to open from the outside because no exterior door handles will be on view. This creation would project high technology and forge the illusion of a more dynamic and intelligent vehicle.

### PATENT OF INVENTION

The current Industrial Property Code, in his essay on May 8, 2000, sets the characters patentability of industrial type aimed at achieving advantages over the already known, admitting therefore patentable, new vehicles, aircraft , tools, manufacturing processes, etc.

According of the above, and based on the articles that collects the ideas expressed should be considered, that the invention to which this report relates, is an industry first, with features and benefits that make it worthy of the privilege of exclusivity and it calls for, thus rewarding the merits of who brings a globalized industry and improves effective precisely between those set by law as patentable.

As is clear from the title, the object to which this report relates is about:

### BACKGROUND OF THE INVENTION

### Related Art

With so many demands on the part of drivers, manufacturers make every effort to develop and implement not only related to the motor system, but also do the same with the look and accessories of vehicles, an example of this relates to exterior door handles which are quite common in vehicles.

Each manufacturer uses different designs to the beat of time and so does the security methods implemented in the handles.

We can refer to U.S. application Ser. No. 10/046,839 Filed: Jan. 15, 2002, U.S. Pat. No. 6,550,103 B2; E05B 1/00 Int C1.; US C1. 16/412, this is on the door handle of a vehicle coupled to open that door, it includes a base which is mounted on the vehicle door and part of the handle is operable to open the door through movement of the handle portion relative to the base.

So we can continue citing references of international patent classifications and the existing system improvements including variants have in common that remain manipulable outside the door of the vehicle at all times. Unfortunately, this can be seen as a problem in a given time.

This paper presents an advantage then that is remarkable because the entire complex will make a movable platform that will hide/show the handle.

### FIELD OF THE INVENTION

The present invention relates to an automatic method to strengthen security at external door handles of cars. This invention achieve that handles a few inches above to slide back (or into the inside of the doors) so then a reinforced protective cover close and seal completely hollow space or outside handle.

This would happen to be inside the vehicle driver driving or when you exit the alarm and activates the vehicle.

One of the most important parts of this method is that hiding the exterior door handles on the inside of the doors as the integrity of the driver is protected when it is within because if you forget to put the locks the doors become disabled to open from outside because the handles exterior will not be in sight.

This creation would project high technology and would forge the illusion of a more dynamic and intelligent vehicle.

### DESCRIPTIVE NOTES

Exposing a synthesis of the various existing features that have external handles, in all matches the disadvantage that remain visible all the time, presenting the risk that they were fraudulently manipulated by third parties at any time. No matter the method used by the manufacturer to open car doors using code key or other current method are always visible outer handles leading to subtract safety.

The main objective pursued with the invention of this new method is in a large percentage reinforce the level of security on the doors of motor vehicles.

They are known for different events that occur in various parts of the world where troublemakers perpetrate vehicles taking advantage of the carelessness of the driver to not put insurance at the door, and this has taken place that the vehicle owner being in this and driving.

The creation of this method eradicate this practice in the world because although the locks are not activated, the exterior door handles would be hidden behind a protective cover reinforced inside vehicle doors.

An additional advantage is that the exterior door handles will remain as new for most of its life, because only be used when you need to use by the owner or authorized persons because otherwise it would be safeguarded inside the doors escaping of the different effects that cause the weather outside.

As an added more security around the moving mechanism must be connected to the central computer of the vehicle and this in turn by the shock sensor serves as an actuator body so that if the driver having an accident or collision in which air bags automatically and immediately soar exterior door handles are displayed, that is to say that they move outward from said doors and available for use this operation would be very important if the driver suffering some faint or collapse due to impact and can not be opened from inside the vehicle because this way there is a possibility that can be opened from the outside using the exterior door handles. This also implies that the door locks if enabled it will automatically turn off. This would help to rescue people inside the vehicle much faster in an emergency.

### BRIEF DESCRIPTION OF THE FIGURES AND REFERENCES

To complete the description that will be made and in order to aid a better understanding of its features this specification a set of drawings which figures illustratively accompanied not limited represented the most significant details of the invention.

FIG. 1.—In it is shown a front perspective view of the slider locking antitheft module also named, in this observes the DC motor with a worm gear type (A), Slider (B) Base sliding lid (C) and Hollow handle Exterior (D).

FIG. 2.—Shows a schematic longitudinal view of the device causing movement of the outer main handles. This includes the following: Base (E), Rails (F), platform motion (G), with their respective DC Motor pinion (H) and brackets for the screws of the base or mount outer handles (I).

FIG. 3.—Represents a side view in which the motors responsible for performing platform mobilization wherein external handles are supported are shown. This support base for motors (M) be welded to the Base Platform Movement (E).

FIG. 4.—A perspective plan module is seen as full mode for better understanding of the mechanism assembly.

FIG. 5.—Is a front view of the base to the outside handle holder which is responsible for holding said handle for further horizontal linear translation towards the inside or towards the outside of the vehicle door shown.

FIG. 6.—It is shown a right side perspective view in which only part of the Module Handle transports can appreciate. This figure denotes the L-type clamping bracket, considering the mode as would installed.

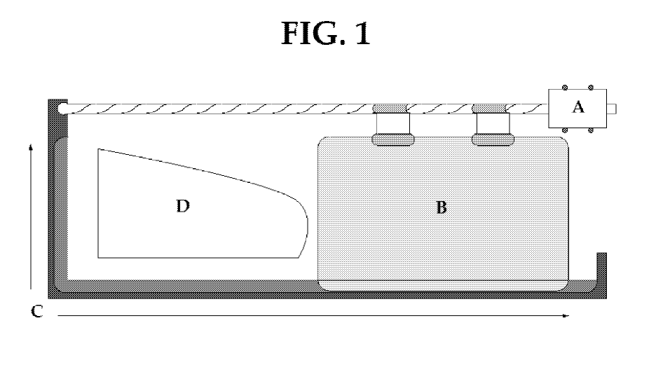

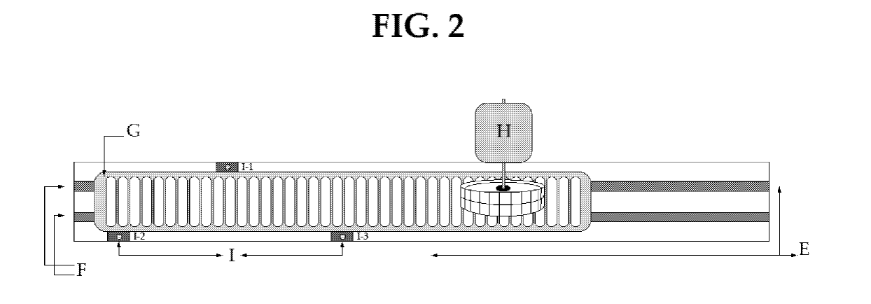

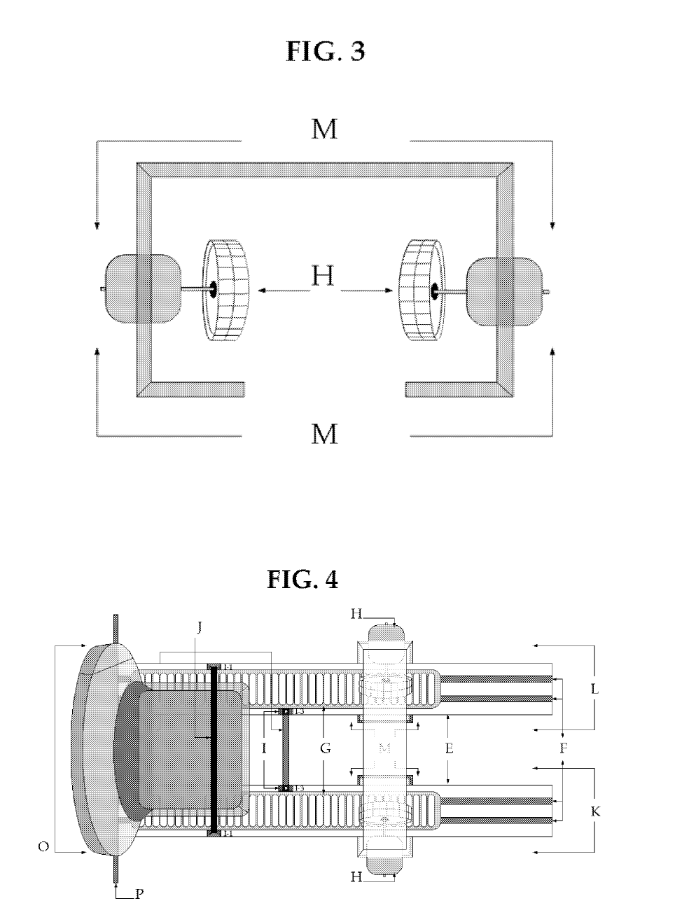

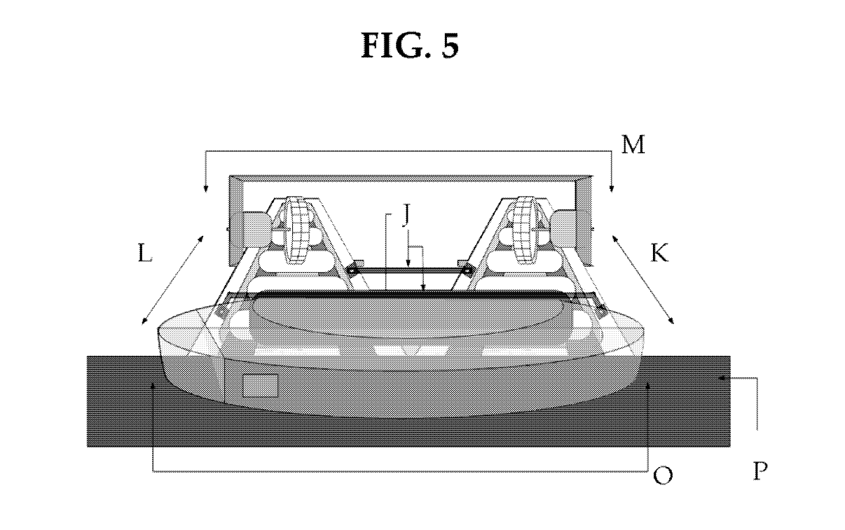

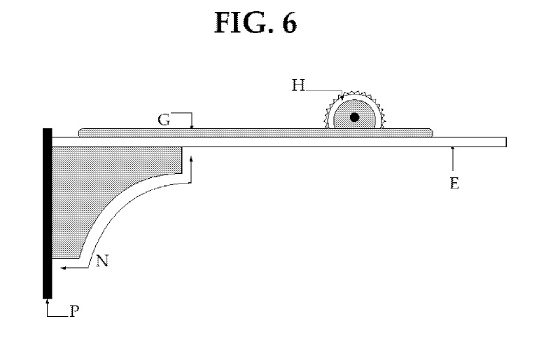

In these figures the following references are indicated:
A.—DC Motor with worm gear type.
B.—Sliding Cover
C.—Sliding Base Cover
D.—Exterior Hollow Handle
E.—Base
F.—Rails
G.—Movement Platform
H.—DC Motor with its pinion
I.—Mounting Screw Mount Base or outer handles.
   I-1.—Center screw Support
   I-2. Screw Left Support
   I-3. Right screw Support
J.—Exterior Handle Base
K.—Left Side Exterior handle Module transports.
L.—Right Side Exterior Handle Module transports.
M.—Support Base Engine.
N.—Support Fixing type L
0.—Exterior Handle top view
P.—Limit or Metal Door

### DESCRIPTION OF THE PREFERRED EMBODIMENT

A description of the invention is performed based on the above mentioned figures.

The basic concept of the invention is constructed with two basic modules, both are attached to metal in the inside of the doors, can begin by installing the slide module wherein the lid must be set based sliding around the space where performed linear horizontal movement from left to right of the slide, said reinforced accessory will be installed subject to rotor type motor worm. It should be noted that the height between the engine and the base should be sufficient to allow the lid or cover is free to move linearly in horizontal direction to bring the locking left and right direction for opening and so allow the passage of the handle outside the door, because the slide was found in the closed position it would not be possible to display and/or using the outside handle, this also throughout the cap must cover the entire hole or recess of the outer handle. Importantly, the speed of this process of horizontal closing left and right opening, should be fast. After such a mechanism is installed, place the second phase of the invention, which corresponds to Handle Module transports.

The base should be fixed which hold the platform horizontal linear movement towards the inside or outside of the door respectively, said platform used to guide rail lines two types for high uniformity and stability in the horizontal movement. As can be seen in Figure II, the motion platform will be powered or driven by attaching a motor, which will be placed just before the end of the platform. It is necessary to emphasize that the platform should be smaller than the base, because this should be a game room for horizontal linear movement towards the inside or outside of the door that held the platform with the outside handle. The engine responsible for causing movement must possess strong pinions which would adjust and accurately in the gutters of the platform to perform the linear translation out and into the car door.

The engine must be secured to a base called engine support (Figure III) which will be linked inseparably to the solid base to hold uniformly both engines.

Through this clarifies that all core responsible for linear translation movement (towards the inside or outside of the door) must be doubled as shown in Figure IV, there is a right and a left to offer more resistance to the various challenges of gravity to mobilize the vehicle; two units also face more strongly receive any blow the door or mechanism for fraudulent purposes. The central unit could work with only one horizontal linear motion module but have more weaknesses and therefore more disadvantages.

Continuing with Figure III, this holder cover both the right and left sides as shown in Figure IV.

An important detail to be expressed is the existence of an L type support, which would be linked between the inner metal of the car door and base for added strength this subject.

Other details to note are the supports for base screws outside handle, as you can see these supports (I-1, I-2, I-3) are part of the motion platform, these lies the basis for outside handle (Figure V) said base comprises three rods connected between motion modules (left and right) for greater stability, strength and resistance to outside handle on the movements to be performed by the entire mechanism.

Build the description that the foregoing disclosure relates to, it should be emphasized that the details of realization of the idea expressed can vary, ie, they may suffer small changes, always based on the fundamental principles of the idea, which are essentially those which are reflected in the paragraphs of the description.

Indeed, it is set by the relevant article as unpatentable “changes of shape, size, proportions and materials of a patented object” thus setting the criterion of the legislator in the sense that patented an idea that could lead to a reality industrializable practice and no one can rely on it for the pretext of having a slightly modified form, present it as new and own.

1. (canceled)

2. (canceled)

3. (canceled)

4. (canceled)

5. (canceled)

6. (canceled)

7. (canceled)

8. (canceled)

9. Movable safety mechanism on the handles of the doors of motor vehicles intended for use in exterior door handles access to cars or motor vehicles, essentially characterized by being constituted by a sliding lock module (to left) and the opening (to the right) this module has a base cover or sliding cover (C) which will remain firmly attached to the inside metal of the vehicle door, the length of the base (C) must be extensive enough to cover the entire space of the outer hollow handle (D) and the slide (B) horizontal linear form, the lid or cover (B) must be subject to long worm rotor type motor (a), is further emphasized that the lid or cover (B) achieved by performing motor (a) two actions; horizontal line leftward thereby obtained as a result the corresponding closure or seal, achieving total protection mechanism, to reverse the linear horizontal motion would move the lid or cover to the right, resulting in the opening of module leading to the second operation.

10. Movable security mechanism, which is characterized by owning a second incorporated module into car doors that works as a complementary mechanism. This second module carrying handle is highlighted by correspond a base solid (E) and inseparable inside metal of the vehicle door, capable of holding the motion platform (G) Importantly, the base (E) has two type rail (F) lines which guide the motion platform (G) in its movement toward the inside of the door or to the outside thereof. The platform movement (G) has a curved channels in which the action of the pinion member to the motor (M) which strongly adjusted accurately and for linear horizontal movement toward the interior or exterior of the vehicle door will be formed. Said motion platform (G) has a support for the base screws outside handle (I) in which three small holes where the screws should be subjected settle. The module has two convenient carrying handle sides, left (K) and right (L), thus provides more resistant to the various challenges of gravity and mobility; means that the unit could function with only one module horizontal linear movement towards the inside or outside, but present major disadvantages; an important additional sustenance is support for motors (M) which will consistently bound to bases (E) with motors (H) ready to produce translational motions of both sides, left and right. This module also has a holding support type L (N) to be placed and inseparably united into solid metal door and the base (E), this so the device has more firmly. The same shall also mentions the existence of a named base frame outside handle (J) which comprises three rods connected between both modules movement left (K) and right (L) achieving enhanced stability, strength and resistance to movements made by the whole mechanism.
